(19) United States
(12) Patent Application Publication
(10) Pub. No.: US 2009/0229291 A1
(43) Pub. Date: Sep. 17, 2009

(54) Cooling System in a Rotating Reference Frame

(75) Inventor: Peter M. Winn, Shrewsbury, MA (US)

Correspondence Address: Occhiuti Rohlicek & Tsao LLP, 10 Fawcett Street, Cambridge, MA, 02138, US

(73) Assignee: American Superconductor Corporation, Devens, MA (US)

(21) Appl. No.: 12/045,973

(22) Filed: Mar. 11, 2008

(51) Int. Cl. F25D 23/00; H02K 9/00; F03D 9/00

(52) U.S. Cl. 62/259.2; 310/58; 290/55

(57) ABSTRACT

A cryogenic cooling system for cooling a thermal load disposed in a rotating reference frame. The cryogenic cooling system includes a cryocooler disposed in the rotating reference frame, the cryocooler including a cold head for cooling the thermal load, and a circulator disposed in the rotating reference frame and connected to the cryocooler, the circulator circulating a coolant to and from the thermal load.

### BACKGROUND

Superconducting rotor field windings of a rotating machine must be cooled while in their superconducting state during operation. The conventional approach to cooling rotor field coils is to immerse the rotor in a cryogenic liquid pool. For example, a rotor employing conventional, low temperature superconducting (“LTS”) materials must be immersed in liquid helium. Similarly, rotors employing field coils made of high temperature superconducting (“HTS”) materials are typically cooled with liquid nitrogen or liquid neon. In either case, heat generated by or conducted in the rotor is absorbed by the cryogenic liquid which undergoes a phase change to the gaseous state. Consequently, the cryogenic liquid must be replenished on a continuing basis.

Another approach for cooling superconducting components is the use of a cryogenic refrigerator or cryocooler. Cryocoolers are mechanical devices operating in one of several thermodynamic cycles such as the Gifford-McMahon (“GM”) cycle and the Stirling cycle. More recently cryocoolers have been adapted for operation with rotors, such as in superconducting motors and generators. One example of doing so is described in U.S. Pat. No. 5,482,919, entitled “Superconducting Rotor”, and incorporated herein by reference. In this approach, a cryocooler system is mounted for co-rotation with a rotor. Mounting the cryocooler cold head for rotation with the rotor eliminates the use of a cryogenic liquid pool for rotor cooling and a cryogenic rotary joint.

Generally, the cold head portion (“cold head”) of a co-rotating cryocooler cools only a local thermal load. When a large thermal load such as a large rotor (e.g., a 36 MW-120 RPM Navy Drive Motor, or 8 MW-11 RPM wind power generator) needs to be cooled, a large cryocooler or a great number of cryocoolers are usually applied to the large thermal load in order to decrease the large thermal gradient generated between the thermal load and the cryocoolers. The additional coolers are typically mounted in the stationary frame, off the rotor, with the cooling power transferred via a helium gas circulation loop (such as described in U.S. Pat. No. 6,357,422) or a thermosiphon liquid cooling loop. Another traditional approach to reducing large thermal gradient is to use heat pipes between the cryocoolers and the thermal load.

### SUMMARY

In one aspect, the invention features a cryogenic cooling system for cooling a thermal load disposed in a rotating reference frame. The cryogenic cooling system includes a cryocooler and a circulator, connected to each other, disposed in the rotating reference frame. The cryocooler has a cold head for cooling the thermal load. The circulator circulates a coolant to and from the thermal load.

Embodiments may include one or more of the following features. The cryocooler is radially positioned about a rotation axis of the rotating reference frame. The circulator is radially positioned about a rotation axis of the rotating reference frame. The thermal load is radially positioned about a rotation axis of the rotating reference frame. The cryogenic cooling system further includes a heat exchanger disposed in the rotating reference frame. The heat exchanger is thermally connected to the cold head. The cold head is a single-stage or a multi-stage device. The circulator circulates the coolant to the thermal load through the heat exchanger. The system further includes a compressor disposed in a stationary reference frame relative to the rotating reference frame. The compressor is in fluid communication with the cryocooler. The system further includes a gas coupling disposed between the rotating reference frame and the stationary reference frame. The gas coupling connects the cryocooler and the compressor. Two or more cryocoolers are disposed in the rotating reference frame. Two or more circulators are disposed in the rotating reference frame. The thermal load is a superconducting winding.

In another aspect, the invention features a rotating electric machine. The rotating electric machine includes a rotating reference frame having a rotation axis, a superconducting winding disposed in the frame, and a cryogenic cooling system disposed in the frame. The cryogenic cooling system includes a cryocooler having a cold head for cooling the superconducting winding, and a circulator connected to the cryocooler. The circulator can circulate a coolant to and from the superconducting winding.

In another aspect, the invention features a wind turbine. The wind turbine includes a rotating electric machine, which includes a rotating reference frame having a rotation axis, a superconducting winding disposed in the frame, and a cryogenic cooling system disposed in the frame. The cryogenic cooling system includes a cryocooler having a cold head for cooling the superconducting winding, and a circulator connected to the cryocooler, the circulator circulating a coolant to and from the superconducting winding.

Embodiments may include one or more of the following features. The cooling system is radially positioned about the rotation axis. The superconducting winding is radially positioned about the rotation axis. The superconducting winding is positioned in a plane parallel to the rotation axis. A plurality of the superconducting windings are equally spaced and radially positioned about the rotation axis within the frame. The cooling system further includes a heat exchanger thermally connected to the cold head. The circulator circulates the coolant to the superconducting winding through the heat exchanger. The cooling system includes two or more of the cryocoolers. The cooling system includes two or more of the circulators. The cooling system includes two or more of the circulators. The cooling system further includes a compressor connected to the cold head. The compressor can co-rotate with the cold head. The compressor receives electrical power through an electrically conducting slip-ring.

Embodiments may provide one or more of the following advantages. The invention provides alternative approaches to reducing large thermal gradients between a co-rotating cryocooler and a thermal load so as to improve the cooling efficiency of the co-rotating cryocooler, especially when the cryocooler is used to cool a large thermal load. By incorporating a circulator (e.g., a circulating fan or a pump) into the rotating reference frame of a cryogenic cooling system, along with the cryocooler, higher cooling power and efficiency can be achieved without requiring a large weight addition to the system. Additionally a cryogenic rotary coupling is not required. This results in less refrigeration costs and higher overall system reliability.

The details of one or more embodiments of the invention are set forth in the accompanying description below. Other features or advantages of the present invention will be apparent from the following drawings, detailed description of several embodiments, and also from the appending claims.

### BRIEF DESCRIPTION OF DRAWINGS

FIG. 1 is a schematic representation of a cooling system in a rotating reference frame.

FIG. 2 is a schematic representation of the cooling system of FIG. 1 in a superconducting rotor.

FIG. 3 is a schematic representation of another embodiment of the cooling system of FIG. 1.

FIG. 4 is a schematic representation of still another embodiment of the cooling system of FIG. 1.

FIG. 5 is a schematic representation of still another embodiment of the cooling system of FIG. 1.

FIG. 6 is a schematic of a wind generator having a rotating machine including the cooling system of FIG. 1 configured to cool HTS rotors of the rotating machine.

### DETAILED DESCRIPTION

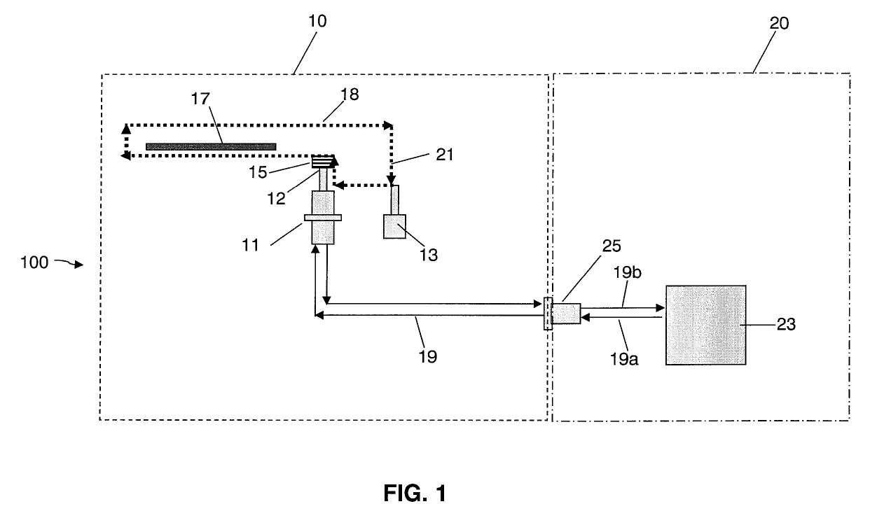

Referring to FIG. 1, a cryocooler 11 and a heat exchanger 15 are disposed in a rotating reference frame 10 of a cryogenic cooling system 100. Heat exchanger 15 is connected to a cold head portion 12 of cryocooler 11. Cryocooler 11 and heat exchanger 15 are used to maintain a coolant 18 (i.e., a cryogenic fluid) at cryogenic temperatures. A circulator 13 (e.g., a cryogenically adaptable fan or pump) is also disposed in frame 10 to move coolant 18 to and from a cryogenic cooling loop 21 (shown as the dotted line with arrows) that is located adjacent and in thermal communication with a thermal load 17 (e.g., a superconducting rotor winding). In essence, circulator 13 serves as the mechanical mechanism for providing the necessary force to move coolant 18 past heat exchanger 15, which is connected to cryocooler 11, and on to thermal load 17. In this arrangement, cryogenic cooling system 100, including cryocooler 11 and circulator 15, helps maintain thermal load 17, e.g., a superconducting winding, at cryogenic temperatures for it to operate properly and efficiently. The cryocooler 11 receives a high pressure working fluid from a compressor 23 through a line 19a. Lower pressure working fluid is returned to compressor 23 through a line 19b. Lines 19a and 19b are in fluid communication with cryocooler 11 through a rotary coupling or junction 25. As illustrated, compressor 23 is disposed in a stationary reference frame 20. As will be described in more detail below, it is generally preferable that an axis of symmetry of coupling 25 be coincident with the rotation axis of rotating reference frame 10.

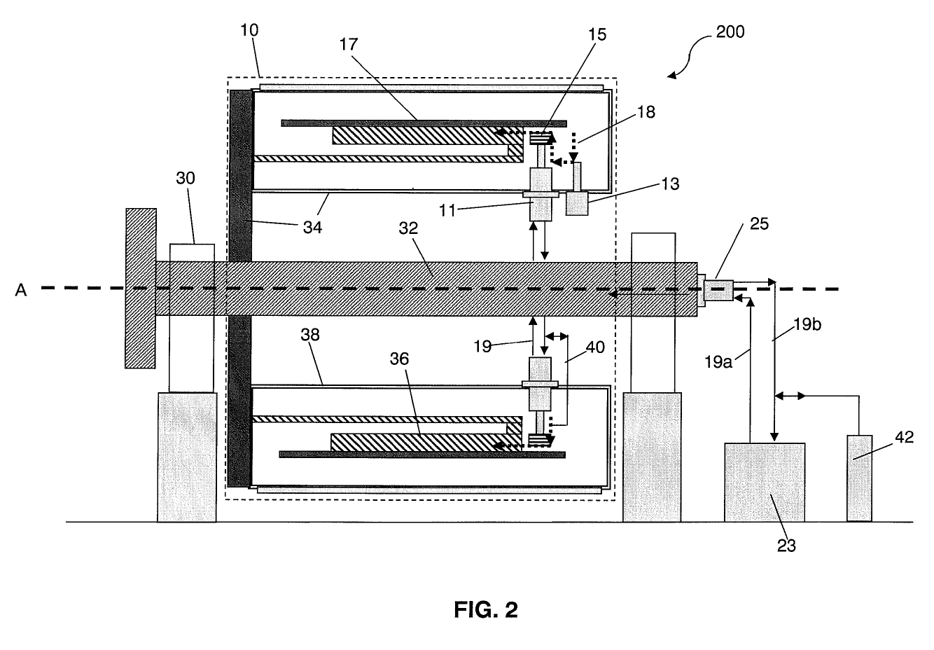

Referring now to FIG. 2, the cryogenic cooling system including the above-described cryocooler 11 and circulator 13 is used in a rotor assembly 200. The rotor assembly 200 generally rotates within a stator assembly (not shown) of a rotating electric machine. The rotor assembly 200 includes a rotating vacuum vessel 38 in the form of a hollow annular member supported by bearings 30 on a shaft 32 that rotates about a rotation axis A. Within vessel 38, a winding support 36 for holding a superconducting winding 17 is fastened to frame elements 34 at least one point to the surface of the vessel. Cryocooler 11 and circulator 13 of the cooling system are also fastened to frame elements 34 of vessel 38. In operation, the superconducting winding is maintained at a cryogenic temperature level (e.g., below 77 Kelvin (K), preferably between 20 and 50 K or between 30 and 40 K) by use of the cryogenic cooling system. In this specific example, two cryocoolers 11 are used. A working gas 19 (e.g., helium) is conveyed to cryocoolers 11 through a coupling 25 which is disposed coaxially to the shaft 32 and between cryocoolers and a compressor 23. As discussed above, circulator 13 forces coolant 18 to move past heat exchanger 15 connected to cryocooler 11 and on to the superconducting winding 17. Coolant 18 decreases the thermal gradient between cryocoolers 11 and thermal load 17 and thus increases cooling efficiency of the cryocooler. Coolant 18 is preloaded in the vessel 38 before operation of the rotating electric machine. In certain applications, when some of the coolant turns into a liquid or solid phase due to overcooling, a make-up line 40 can supply gas-phase coolant (e.g., helium gas) as needed. Make-up line 40 is connected to a make-up gas source 42 (e.g., a gas bottle) through the supply line of the working gas 19.

The cryocooler forming a part of the present invention may be a single-stage or a multi-stage device. Suitable cryocoolers include those that can operate using any appropriate thermodynamic cycle such as the Gifford-McMahon cycle and the Stirling cycle, a detailed description of which can be found in U.S. Pat. No. 5,482,919. Preferably, a Helix Technologies Cryodyne Model 1020 is used in this invention. The circulator is selected for suitability for operating in a cryogenic environment. Such circulator is manufactured by American Superconductor and a smaller version (e.g., Model A20) is manufactured by Stirling Technologies. Suitable coolants and/or working fluids for use with the circulator and cryocooler include, but are not limited to, helium, neon, nitrogen, argon, hydrogen, oxygen, and mixtures thereof. The superconductor material forming the superconducting winding may be conventional, low temperature superconductors such as niobium-tin having a transition temperature below 35 K, or a high temperature superconductor having a transition temperature above 35 K. Suitable high temperature superconductors for the field coils are members of the bismuth-strontium-calcium-copper oxide family, the yttrium-barium-copper oxide system, mercury based materials and thallium-based high temperature superconductor materials. The rotary coupling 25, in one example, includes a gas-to-gas inner seal and a ferrofluid outer seal. Details of the coupling have been described in U.S. Pat. No. 6,536,218, the content of which is herein incorporated by reference.

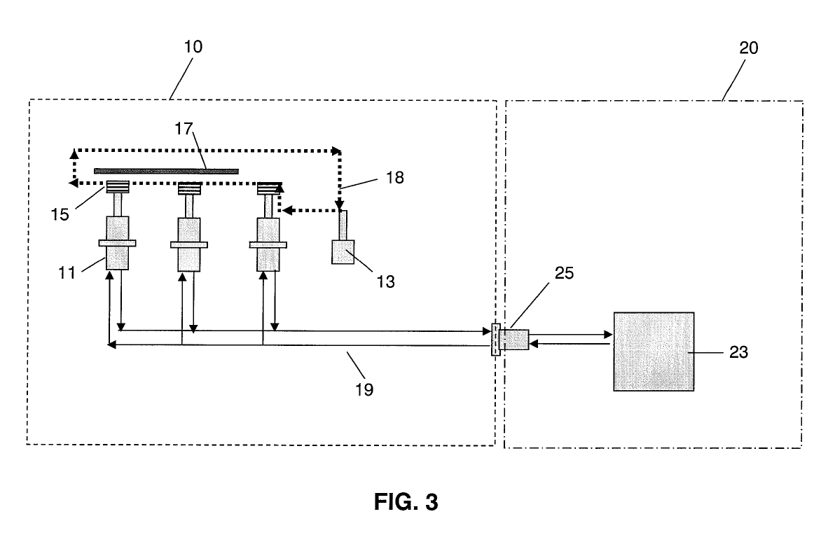

Referring to FIG. 3, in another embodiment, more than one cryocooler 11 are used to help maintain each superconducting winding at cryogenic temperatures. In this embodiment, three cryocoolers 11 are disposed in close proximity to superconducting winding 17. One circulator 13 is used to move coolant 18 to and from the winding. In this specific example, the cryocoolers and the circulator have their axes of symmetry perpendicular to the rotation axis A of rotating reference frame 10.

Among other advantages, using more than one cryocooler 11 increases efficiency and ease of maintenance. In particular, employing more than one cryocooler 11 arranged in series reduces the work load of each cryocooler, so that each cryocooler works less to lower the temperature of coolant 18. Also, if one cryocooler malfunctions, the redundancy in the system overcomes any loss. Further, if one cryocooler does malfunction, it can be isolated from the system by proper valving to allow maintenance to be performed without shutting down the system and without introducing contaminants into the system.

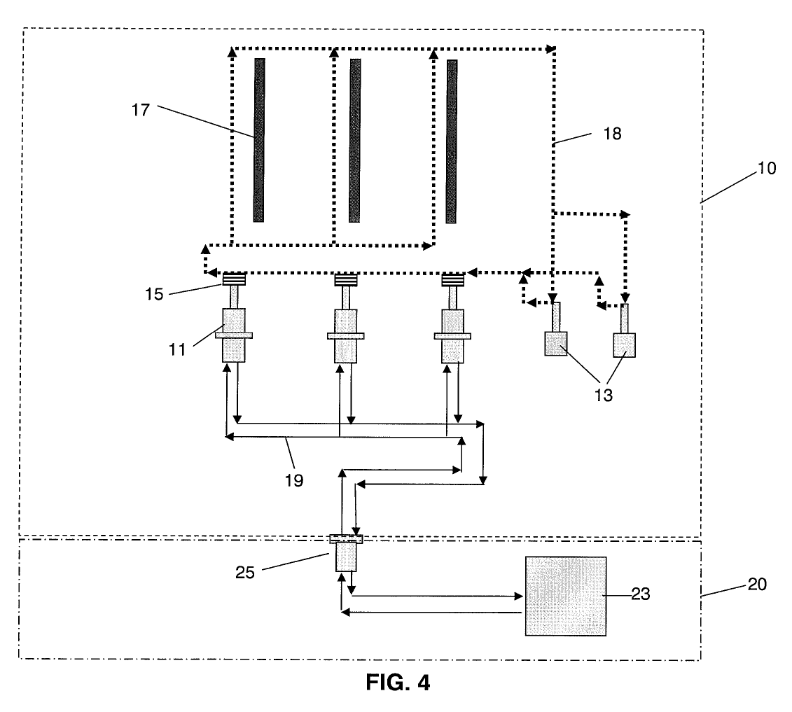

Referring to FIG. 4, in still another embodiment, more than one circulator 13 is used together with one or more cryocoolers. For example, in this embodiment, two circulators 13 and three cryocoolers 11 are disposed in rotating reference frame 10. The circulators and the cryocoolers have their axes of symmetry parallel to the rotation axis of the rotating reference frame. Similar to using multiple cryocoolers in the cooling system, using multiple circulators provides redundancy and facilitates maintenance in the event that one of the circulators requires maintenance or replacement. Appropriate valve and bypass conduits are required to allow each of circulator 13 to be isolated from the other while allowing continuous operation of the system.

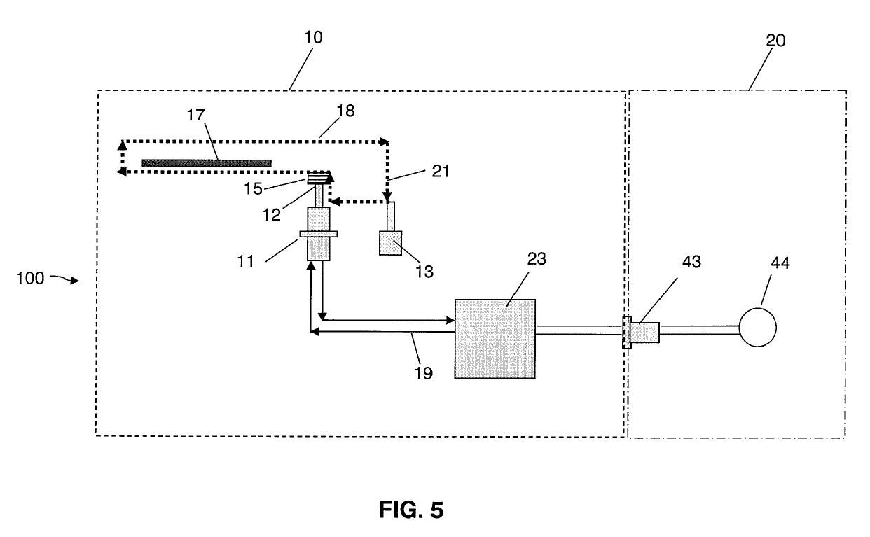

FIG. 5 shows another embodyment of the invention in which both cryocooler cold head 11 and compressor 23 are mounted for rotation in rotating reference frame 10. An electrically conducting slip-ring 43 allows electricity to be transported to compressor 23 from a non-rotating source of electrical energy 44. The embodiment of FIG. 5 obviates fluid rotary coupling 25 of the embodyment of FIG. 1.

In all embodiments, it is generally preferable that the superconducting windings are radially positioned about the rotation axis of the rotating reference frame to which it is attached, and have their longitudinal axes parallel to the rotation axis. It is also preferable that the cryocoolers as well as the circulators are also radially positioned about the rotation axis of the rotating reference frame. Their axes of symmetry are either parallel or non-parallel to the rotation axis.

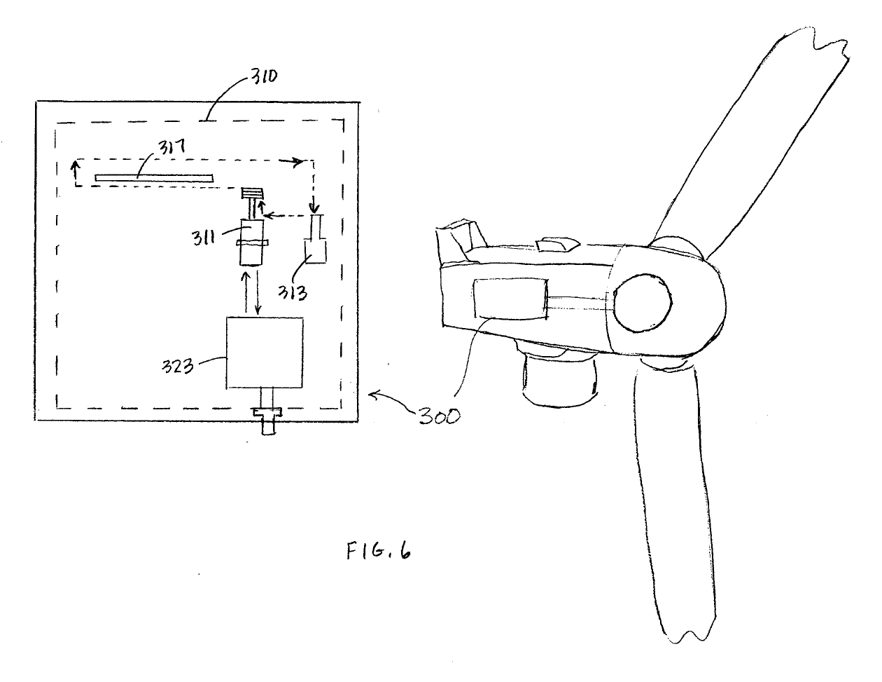

There are many applications in which superconducting rotor field windings of a rotating machine must be cooled while in their superconducting state during operation. One example of such an application includes an HTS wind generator 300 employed in a wind turbine (FIG. 6). Such generators 300 include rotors, here represented by rotating reference frame 310. The rotors employ coils 317 made of high temperature superconducting (“HTS”) materials. As seen in the figure, the HTS coils 317 of the wind generator 300 are cooled using the above-described cooling system in which at least one cryocooler 311 and at least one circulator 313 are disposed in the rotating reference frame 310 of the rotor. In some embodiments, a compressor 323 may also be disposed in the rotating reference frame 310.

### Other Embodiments

All of the features disclosed in this specification may be combined in any combination. Each feature disclosed in this specification may be replaced by an alternative feature serving the same, equivalent, or similar purpose. For example, coolant 18, instead of being preloaded in the cooling system before operation, can be supplied through make-up line 40 once operation starts. For another example, when a physical cryogenic cooling loop 21 may be absent, and coolant 18 (e.g., helium gas) is dispersed randomly within vessel 38. In this case, circulator 13 moves the coolant to and from thermal load 17 to decrease the thermal gradient while cryocooler 11 cools the coolant to a suitable low temperature. In addition, rotating vessel 38, in certain applications, does not require a vacuum condition. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the scope of the following claims.

What is claimed is:

1. A cryogenic cooling system for cooling a thermal load disposed in a rotating reference frame, the cryogenic cooling system comprising:
a cryocooler disposed in the rotating reference frame, the cryocooler including a cold head for cooling the thermal load, and
a circulator disposed in the rotating reference frame and connected to the cryocooler, the circulator circulating a coolant to and from the thermal load.

2. The system of claim 1, wherein the cryocooler is radially positioned about a rotation axis of the rotating reference frame.

3. The system of claim 1, wherein the circulator is radially positioned about a rotation axis of the rotating reference frame.

4. The system of claim 1, wherein the thermal load is radially positioned about a rotation axis of the rotating reference frame.

5. The system of claim 1 further comprising a heat exchanger disposed in the rotating reference frame, the heat exchanger thermally connected to the cold head.

6. The system of claim 5, wherein the circulator circulates the coolant to the thermal load through the heat exchanger.

7. The system of claim 1 further comprising a compressor disposed in a stationary reference frame relative to the rotating reference frame, the compressor being in fluid communication with the cryocooler.

8. The system of claim 7 further comprising a gas coupling disposed between the rotating reference frame and the stationary reference frame, the gas coupling connecting the cryocooler and the compressor.

9. The system of claim 1, wherein two or more cryocoolers are disposed in the rotating reference frame.

10. The system of claim 9, wherein two or more circulators are disposed in the rotating reference frame.

11. The system of claim 1, wherein the thermal load is a superconducting winding.

12. A rotating electric machine comprising:
a rotating reference frame having a rotation axis,
a superconducting winding disposed in the frame, and
a cryogenic cooling system disposed in the frame, the system including:
a cryocooler having a cold head for cooling the superconducting winding, and a circulator connected to the cryocooler, the circulator circulating a coolant to and from the superconducting winding.

13. The machine of claim 12, wherein cooling system is radially positioned about the rotation axis.

14. The machine of claim 12, wherein the superconducting winding is radially positioned about the rotation axis.

15. The machine of claim 14, wherein the superconducting winding is positioned in a plane parallel to the rotation axis.

16. The machine of claim 12, wherein the cooling system further includes a heat exchanger thermally connected to the cold head.

17. The machine of claim 16, wherein the circulator circulates the coolant to the superconducting winding through the heat exchanger.

18. The machine of claim 12, wherein a plurality of the superconducting windings are equally spaced and radially positioned about the rotation axis within the frame.

19. The machine of claim 12, wherein the cooling system includes two or more of the cryocoolers.

20. The machine of claim 19, wherein the cooling system includes two or more of the circulators.

21. The machine of claim 12, wherein the cooling system includes two or more of the circulators.

22. The machine of claim 12, wherein the cooling system further includes a compressor connected to the cold head.

23. A wind turbine comprising:
a rotating electric machine, the rotating electric machine including:
a rotating reference frame having a rotation axis,
a superconducting winding disposed in the frame, and
a cryogenic cooling system disposed in the frame, the system including:
a cryocooler having a cold head for cooling the superconducting winding, and
a circulator connected to the cryocooler, the circulator circulating a coolant to and from the superconducting winding.
